(19) United States
(12) Patent Application Publication
(10) Pub. No.: US 2026/0088879 A1
(43) Pub. Date: Mar. 26, 2026

(54) PERFORMANCE MONITORING FOR ARTIFICIAL INTELLIGENCE (AI) MODEL-BASED CHANNEL STATE INFORMATION (CSI) FEEDBACK

(71) Applicant: Apple Inc., Cupertino, CA (US)

(72) Inventors: Huaning Niu, San Jose, CA (US); Dawei Zhang, Saratoga, CA (US); Haitong Sun, Cupertino, CA (US); Wei Zeng, Saratoga, CA (US); Seyed Ali Akbar Fakoorian, San Diego, CA (US); Weidong Yang, San Diego, CA (US); Oghenekome Oteri, San Diego, CA (US); Chunhai Yao, Beijing (CN); Sigen Ye, Whitehouse Station, NJ (US)

(21) Appl. No.: 19/112,666

(22) PCT Filed: Sep. 30, 2022
(86) PCT No.: PCT/CN2022/123201

§ 371 Date: Mar. 18, 2025

(51) Int. Cl. H04B 7/06; H04L 41/16; H04W 8/22

(52) U.S. Cl. CPC H04B 7/0658; H04B 7/0626; H04B 7/0632; H04B 7/0639; H04L 41/16; H04W 8/22

(57) ABSTRACT

A user equipment (UE) includes a transceiver and a processor configured to transmit, via the transceiver to a network, UE capability information that corresponds with performance monitoring for artificial intelligence (AI) model-based channel state information (CSI) compression at the UE. In accordance with the UE capability information, the processor is configured to receive, via the transceiver and from the network, configuration and activation instructions for performing the AI model-based CSI compression and a network configuration on assisted information for the performance monitoring. The processor is configured to monitor performance of the AI model-based CSI compression in accordance with the received UAI configuration, and based on the monitored performance of the AI model-based CSI compression, transmit, via the transceiver to the network, a preference of the UE for the AI model-based CSI compression.

### TECHNICAL FIELD

This application relates generally to wireless communication systems, including methods and systems for performance monitoring for artificial intelligence (AI) model-based channel state information (CSI) feedback.

### BACKGROUND

Wireless mobile communication technology uses various standards and protocols to transmit data between a network device (e.g., a base station) and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device used by a RAN may correspond to that RAN. One example of an E-UTRAN network device is an Evolved Universal Terrestrial Radio Access Network (E-UTRAN) Node B (also commonly denoted as evolved Node B, enhanced Node B, eNodeB, or eNB). One example of an NG-RAN network device is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 illustrates an example message flow between a network device and a user equipment (UE), according to embodiments described herein.

FIG. 3 illustrates another example message flow between a network device and a user equipment (UE), according to embodiments described herein.

FIG. 4 illustrates yet another example message flow between a network device and a user equipment (UE), according to embodiments described herein.

FIG. 5 illustrates an example architecture of a wireless communication system, according to embodiments disclosed herein.

FIG. 6 illustrates a system for performing signaling between a wireless device and a network device, according to embodiments disclosed herein.

### DETAILED DESCRIPTION

Various embodiments in the present disclosure are directed to methods and systems for performance monitoring of artificial intelligence (AI) model-based channel state information (CSI) feedback (or CSI compression feedback), and deactivating AI model-based CSI feedback in the case when the CSI report does not meet a specific criterion. AI model-based CSI feedback may reduce overhead, improve accuracy, and improve channel prediction. However, AI mode-based CSI feedback may not always result in the improved channel prediction. Accordingly, a determination needs to be made whether the AI model performs satisfactorily, needs to switch to a different AI model, or to fall back to a traditional or legacy CSI feedback method. Currently, for CSI feedback, the AI model may be trained according to various frameworks, which includes type-1 (joint training of the two-sided AI model at a single entity, e.g., a UE or a network), type-2 (joint training of the two-sided AI model at a UE and a network), and type-3 (separate training at a network and a UE with the UE generating a CSI report and the network performing CSI reconstruction).

As described in the present disclosure, joint training may include training a model for generating a CSI report at a UE-side and a model for reconstruction at a network-side in the same loop for forward propagation and backward propagation. Further, the joint training may be performed using a single node or across multiple nodes, which, for example, may be performed using a gradient exchange between nodes. A separate training may include training a model on a UE-side and a model on a network-side sequentially, in which the UE-side or the network-side model may be trained first, or may be performed in parallel. Other frameworks, in addition to the type-1, the type-2, and/or the type-3, and not mentioned in the present disclosure may also be used.

Reference will now be made in detail to representative embodiments/aspects illustrated in the accompanying drawings. The following description is not intended to limit the embodiments to one preferred embodiment. On the contrary, it is intended to cover alternatives, combinations, modifications, and equivalents as can be included within the spirit and scope of the described embodiments as defined by the appended claims.

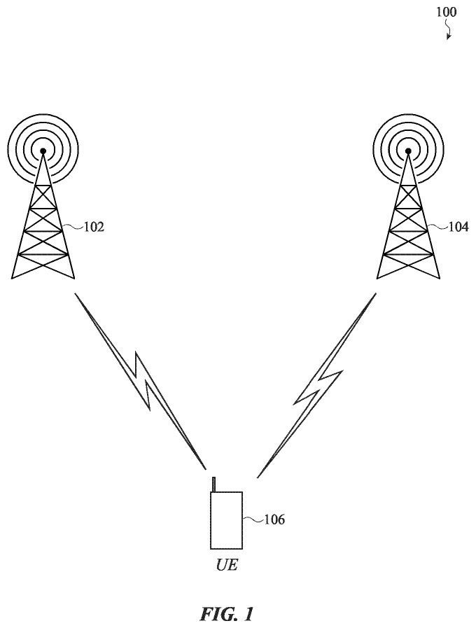

FIG. 1 shows an example wireless communication system, according to embodiments described herein. As shown in FIG. 1, a wireless communication system 100 may include a network device 102, a network device 104, and a user equipment (UE) 106. The UE 106 may be communicatively coupled with the network device 102 and/or the network device 104, to transmit data in an uplink (UL) direction and/or to receive data in a downlink (DL) direction. In some embodiments, the network devices 102, and 104 may be an eNb, an eNodeB, a gNodeB, or an access point (AP) in a radio access network (RAN) and may support one or more radio access technologies, such as 4G, 5G, 5G new radio (5G NR), and so on. The UE 106 may be a phone, a smart phone, a tablet, a smartwatch, an Internet-of-Things (IOT), a vehicle, and so on.

A CSI report describes a state of a channel. A UE may transmit a CSI report to a network device as feedback. The CSI report may include several parameters, such as a channel quality indicator (CQI), a precoding matrix indicator (PMI) with different codebook sets, and a rank indicator (RI). The UE may use a channel state information reference signal (CSI-RS) to measure CSI feedback and generate a CSI report. Upon receiving the CSI report, the network device may schedule data transmission in a DL direction.

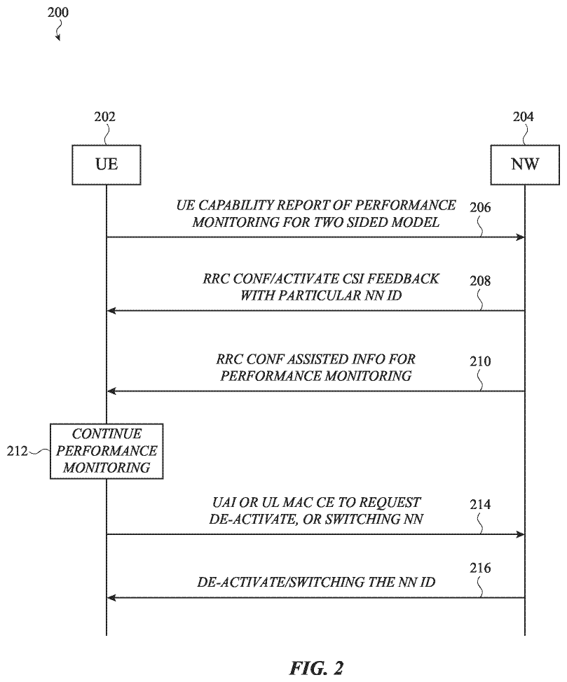

In some embodiments, performance monitoring for CSI feedback may be performed using a two-sided model as described herein, the performance monitoring performed at the UE-side and at the network-side. Performance monitoring at the UE-side is described using FIG. 2 below.

FIG. 2 illustrates an example message flow between a network device and a user equipment (UE), according to embodiments described herein. A message flow 200 shown in FIG. 2 describes performance monitoring at the UE-side for CSI feedback. As shown in the message flow 200, messages are exchanged between a UE 202 and a network 204. The network 204 may include a network device (e.g., the network device 102 or 104), a core network, and/or a radio access network (RAN). The UE 202 may transmit, to the network 204, UE capability information (or a UE capability report) regarding performance monitoring for AI model-based CSI compression feedback (or CSI feedback), which is shown in FIG. 2 as 206. The AI model-based CSI feedback may be based on a two-sided model of type-1, type-2, and/or type-3, described herein.

The UE capability information may include whether the UE supports download of a decoder model, and/or whether the UE can perform inferencing of the decoder model. By way of a non-limiting example, the UE capability information regarding whether the UE supports download of the decoder model is indicated if the network 204 indicates that a decoder model is available for download by the UE 202. However, for the AI model-based CSI feedback of type-1, where the encoder or decoder, for example, for CSI compression model and/or CSI reconstruction model, is trained at the UE-side, the UE capability information may not include UE's capability regarding downloading of the decoder model because the UE already has the particular decoder after training. The decoder model, when downloaded by the UE, can perform, evaluate, or compare the CSI reference signal (CSI-RS) measurement based on the AI model using the downloaded decoder model from the network 204, and inferencing the downloaded decoder model at the UE 202.

Based on the received UE capability information at 206, the network 204 may transmit, to the UE 202, a configuration and activation instructions for performing the AI model-based CSI compression, which is shown as 208. In particular, the configuration may include an identification (ID) of an AI model. Though the UE 202 uses an AI model for CSI feedback, the UE may be configured with more than one AI model to perform CSI-RS measurements and generate a CSI report. A particular AI model, to perform CSI-RS measurements and generate the CSI report, may be selected by the UE 202, or configured at the UE using an ID of an AI model. The ID of an AI model may be instructed to the UE 202 by the network 204. Further, the network 204 may transmit to the UE 202 activation instructions to use the AI model that is identified using the AI model ID. The configuration and activation instructions may be transmitted to the UE 202 from the network 204 using radio resource control (RRC) signaling.

The network 204 may also transmit to the UE 202, as shown in FIG. 2 as 210, a network configuration on assisted information for performance monitoring of the AI model-based CSI feedback. In some embodiments, and by way of a non-limiting example, the network configuration on assisted information for performance monitoring received at the UE 202 from the network 204 may include a configuration of an intermediate metric threshold of a metric. The configuration of the intermediate metric threshold of the metric may be included in the network configuration on assisted information for performance monitoring if the UE indicates in the UE capability information (or UE capability report) whether the UE can perform inferencing of the downloaded decoder model. In some examples, the metric may be a generalized cosine similarity metric, a squared generalized cosine similarity, or a normalized mean square error (MSE) metric. Other types of metrics may also be used.

Since the UE supports inferencing of a decoder model, the UE may perform an encoder function (or encoding) based on CSI-RS measurements. Thus, the UE performs encoding and/or decoder model inferencing. The UE may generate an eigen-vector of the metric. The generated eigen-vector based on the configured intermediate threshold may be compared against the decoder output based on inferencing of the decoder model output. Based on the comparison, if the intermediate threshold of the eigen-vector exceeds the configured intermediate threshold value, then the CSI feedback based on the AI model may be considered to meet the requirements; otherwise, the CSI feedback based on the AI model may be considered failed to meet the requirements, and another AI model may be required for a CSI report or another alternative, as described herein, may be required.

In some embodiments, the eigen-vector (or an intermediate threshold of the eigen-vector) may be generated by averaging measurements over a particular time window. By averaging measurements over a particular time window, the eigen-vector generated may have a higher or improved accuracy. The particular time window for averaging measurements may be configured by the network 204 using the network configuration on assisted information for performance monitoring at 210.

For training collaboration of type-3 with a UE-first training, where a UE trains an encoder and a decoder together, then generate separate datasets of an encoder output and a decoder output for a network to train its own decoder (or a network-side decoder), the UE may use its own decoder (or a UE-side decoder) to calculate a reconstructed PMI for performance monitoring, if the UE does not support downloading of a decoder from a network.

In some embodiments, when the UE does not support decoder model inferencing, the network configuration on assisted information for performance monitoring from the network 204 to the UE 202 at 210 may include a block error rate (BLER) threshold of a physical downlink shared channel (PDSCH). The configured BLER threshold may correspond with a hypothetical PDSCH transmission. The UE may generate an eigen-vector based on the performed CSI-RS measurements, and calculate a channel quality indicator (CQI) based on the generated eigen-vector. The UE may calculate BLER for PDSCH, and compare it with the BLER threshold of PDSCH in the UAI configuration. If the calculated BLER for PDSCH is higher that the BLER threshold of PDSCH in the UAI configuration, then the UE may determine that the particular AI model used for CSI feedback does not meet requirements or performance criteria. In some embodiments, the PDSCH BLER may be calculated by averaging measurements over a particular time window that is configured at the UE using the UAI configuration. The UAI information is sent to the UE 202 by the network 204 using RRC signaling.

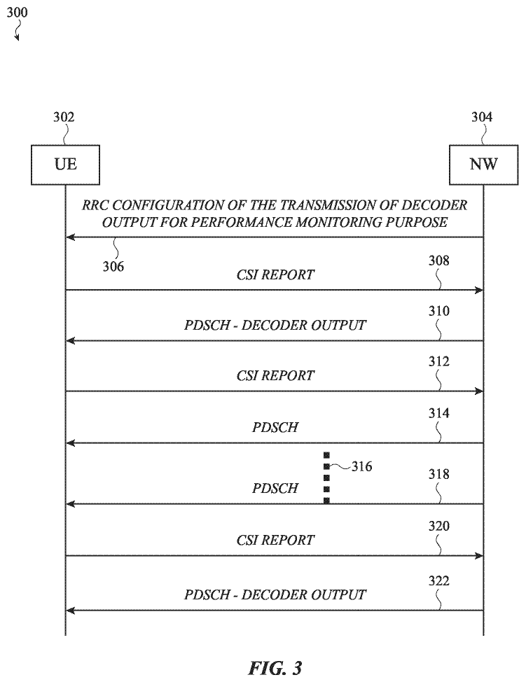

In some embodiments, when the UE does not support decoder model inferencing, the network 204 may transmit to the UE 202 a decoder output. The decoder output may be a precoder matrix index (PMI). The PMI may be generated or reconstructed at the network 204. This use case or scenario is described in detail using FIG. 3 below.

As shown in FIG. 2 as 212, the UE 202 may perform CSI-RS measurements for monitoring performance of the AI model-based CSI feedback (or CSI compression feedback) using the network configuration on assisted information for performance monitoring and an AI model identified using an AI model ID. By way of a non-limiting example, the AI model may be a neural network based AI model, and the AI model ID may be a neural network (NN) ID. The CSI feedback may indicate whether the AI model meets requirements or performs satisfactorily/unsatisfactorily as described herein based on the UAI configuration or the decoder output received from the network.

At 214, based on the CSI feedback or monitored performance of the AI model-based CSI compression feedback (or CSI feedback), which identifies whether the AI model performs satisfactorily or unsatisfactorily, the UE may send its preference using a UAI message or a UL MAC control element (MAC CE). In cases where the AI model is performing unsatisfactorily, the UE's preference may include deactivation of the AI model-based CSI compression feedback (or CSI feedback), or switching to another AI model-based CSI compression feedback (or CSI feedback).

At 216, the network 204 may transmit to the UE 202 a configuration and instructions for deactivating the AI model-based CSI compression, or switching to the other AI model-based CSI compression. In some embodiments, the configuration and instructions for deactivating the AI model-based CSI compression, or switching to the other AI model-based CSI compression may be transmitted via RRC signaling, a MAC CE, or DCI. The UAI message from the UE 202 to the network 204 at 214 may take a comparatively longer time for the network 204 to perform an operation corresponding to 216. Accordingly, to prevent the UE from requesting frequent changes for performance monitoring using AI model-based CSI feedback, a prohibit timer may be configured at the UE. Accordingly, while the prohibit timer is running or active, the UE cannot perform 214.

FIG. 3 illustrates another example message flow between a network device and a user equipment (UE), according to embodiments described herein. As shown in FIG. 3 as a message flow 300, when a UE 302 does not support decoder model inferencing, a network 304 may transmit to the UE 302 a decoder output, which is shown as 306. The decoder output may be a precoder matrix index (PMI). The PMI may be generated or reconstructed at the network 304. The decoder output may be transmitted from the network 304 via RRC signaling.

By way of a non-limiting example, the decoder output may be periodically sent to the UE 302, which is shown in FIG. 3 as 310, 314, 318, and/or 322. Periodicity of decoder output transmission at the network 304 may be preconfigured or can be dynamically configured. The decoder output may be transmitted as part of PDSCH transmission. The decoder output may have a different resolution. For example, the decoder output may be of high resolution, which corresponds to 16 or 32 bits quantizer per element. The UE 302 may buffer the CSI-RS measurements and/or an eigen-vector for comparison with the decoder output received at 306. The eigen-vector may be generated based on a metric, such as a generalized cosine similarity metric, a squared generalized cosine similarity, or a normalized mean square error (MSE) metric.

By way of a non-limiting example, the UE may not buffer each CSI-RS measurement and/or an eigen-vector for comparison with the decoder output, and the UE may be configured or preconfigured to buffer certain CSI-RS measurements and/or an eigen-vector for comparison with the decoder output. In some embodiments, which CSI-RS measurements and/or an eigen-vector to buffer for comparison with the decoder output may be determined by the UE according to UE implementation.

At 308, the UE 302 may generate a CSI report to transmit to the network 304. The UE 302 may periodically transmit a CSI report to the network 304, as shown in FIG. 3 as 312, and/or 320.

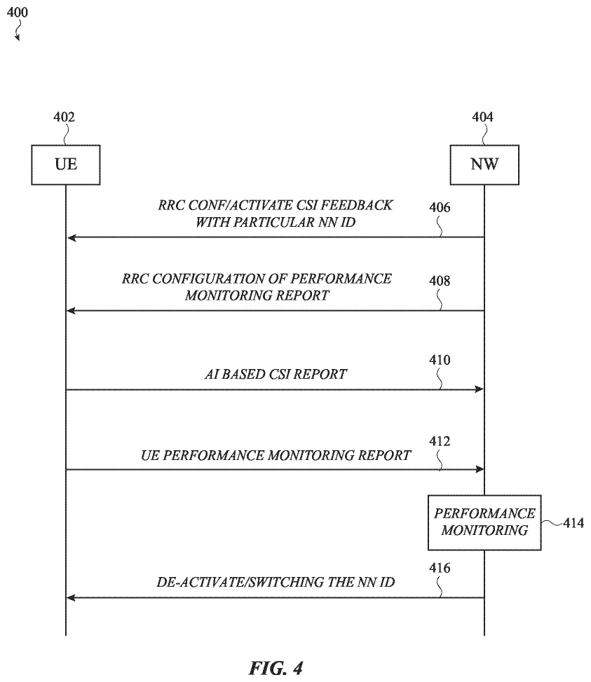

FIG. 4 illustrates yet another example message flow between a network device and a user equipment (UE), according to embodiments described herein. In particular, a message flow 400 shown in FIG. 4 may be related to performance monitoring of AI model-based CSI feedback at a network-side. As shown in FIG. 4 as 406, a network 404 may transmit to a UE 402, a configuration and activation instructions for performing the AI model-based CSI compression. In particular, the configuration may include an identification (ID) of an AI model. Though the UE 402 uses an AI model for CSI feedback, the UE may be configured with more than one AI model to perform CSI-RS measurements and generate a CSI report. A particular AI model, to perform CSI-RS measurements and generate the CSI report, may be selected by the UE 402, or configured at the UE using an ID of an AI model. The ID of an AI model may be instructed to the UE 402 by the network 404. Further, the network 404 may transmit to the UE 402 activation instructions to use the AI model that is identified using the AI model ID. The configuration and activation instructions may be transmitted to the UE 402 from the network 404 using RRC signaling.

At 408, the network 404 may transmit to the UE 402 a configuration for a UE report (or a CSI report) for performance monitoring on the network-side. The configuration for the UE report may include or indicate whether the UE needs to transmit an eigen-vector or measured CSI-RS measurements (e.g., channel matrix). The configuration transmitted at 408 may include a periodicity or a frequency at which the UE needs to transmit the CSI report to the network 404, feedback format (e.g., 32 bit per floating bit value), and so on. In some embodiments, and by way of a non-limiting example, when the periodicity or the frequency at which the UE 402 needs to transmit the CSI report to the network 404, the CSI report may be requested by the network 404 using a downlink (DL) MAC control element (MAC CE) or downlink control information (DCI). By way of a non-limiting example, the CSI report may be requested using DL MAC CE or DCI along with aperiodic CSI-RS (AP-CSI-RS) triggering.

In some embodiments, the configuration transmitted at 408 may configure the UE 402 to transmit traditional codebook feedback at 410. The traditional codebook feedback may be periodic, aperiodic, and/or semi-persistent feedback. In some embodiments, the UE 402 may transmit to the network 404 a UE capability report including the UE's capability to support generation of a CSI report based on a traditional codebook and an AI model simultaneously. Alternatively, the UE 402 may transmit to the network 404 a UE capability report including the UE's capability to support generation of a CSI report based on a traditional codebook and an AI model separately, or generation of a CSI report based on a traditional codebook or an AI model.

At 410, the UE 402 may transmit to the network 404 the CSI report based on the configuration received at 408. The CSI report may be transmitted as part of physical uplink shared channel (PUSCH) transmission or UL control information (UCI).

In some embodiments, if the UE indicated in the UE capability report that the UE can support generation of a CSI report based on a traditional codebook and an AI model simultaneously, a single CSI report transmitted at 410 may include both AI model-based CSI feedback and traditional codebook based CSI feedback. The AI model-based CSI feedback and the traditional codebook-based CSI feedback included in the single CSI report may be based on the same CSI-RS measurement.

In some embodiments, if the UE indicated in the UE capability report that UE supports generation of a CSI report based on a traditional codebook and an AI model separately, or generation of a CSI report based on a traditional codebook or an AI model, the UE may transmit a separate CSI report corresponding to the traditional codebook and the AI model. A CSI report corresponding to the traditional codebook and a CSI report corresponding to the AI model may be based on the same or different CSI-RS measurements. While generating a CSI report corresponding to the traditional codebook and a CSI report corresponding to the AI model based on the same CSI-RS measurements, the CSI-RS measurements may be buffered, for example, for delayed processing.

At 412, the UE 402 may transmit to the network 404 a CSI report based on the traditional codebook. The CSI report based on the traditional codebook (also referenced herein as a UE report) may be transmitted to the network 404 for performance monitoring. The CSI report based on the traditional codebook may be generated based on availability of computing or processing power at the UE 402.

At 414, the network may evaluate, or perform comparison of, the CSI report based on the AI model received at 410 and the UE report received at 412. Based on the evaluation, at 416, the network 404 may transmit to the UE 402 instructions to deactivate CSI feedback based on the AI model if it is determined at 414 that there is a degradation of performance using the AI model identified using the AI model ID specified in the configuration at 406. Additionally, or alternatively, the network 404 may instruct the UE 402 to switch to non-AI model-based CSI compression, or use a different AI model (e.g., specify a different AI model ID).

Embodiments contemplated herein include an apparatus having means to perform one or more elements of the flow-charts 200, 300, or 400. In the context of method 200, 300, or 400, the apparatus may be, for example, an apparatus of a UE (such as a wireless device 602 that is a UE, as described herein). In the context of method 200, 300, or 400, the apparatus may be, for example, an apparatus of a network device (such as a network device 620, as described herein).

Embodiments contemplated herein include one or more non-transitory computer-readable media storing instructions to cause an electronic device, upon execution of the instructions by one or more processors of the electronic device, to perform one or more elements of the method 200, 300, or 400. In the context of method 200, 300, or 400, the non-transitory computer-readable media may be, for example, a memory of a UE (such as a memory 606 of a wireless device 602 that is a UE, as described herein). In the context of method 200, 300, or 400, the non-transitory computer-readable media may be, for example, a memory of a network device (such as a memory 624 of a network device 620, as described herein).

Embodiments contemplated herein include an apparatus having logic, modules, or circuitry to perform one or more elements of the method 200, 300, or 400. In the context of method 200, 300, or 400, the apparatus may be, for example, an apparatus of a UE (such as a wireless device 602 that is a UE, as described herein). In the context of method 200, 300, or 400, the apparatus may be, for example, an apparatus of a network device (such as a network device 620, as described herein).

Embodiments contemplated herein include an apparatus having one or more processors and one or more computer-readable media, using or storing instructions that, when executed by the one or more processors, cause the one or more processors to perform one or more elements of the method 200, 300, or 400. In the context of method 200, 300, or 400, the apparatus may be, for example, an apparatus of a UE (such as a wireless device 602 that is a UE, as described herein). In the context of the method 200, 300, or 400, the apparatus may be, for example, an apparatus of a network device (such as a network device 620, as described herein).

Embodiments contemplated herein include a signal as described in or related to one or more elements of the method 200, 300, or 400.

Embodiments contemplated herein include a computer program or computer program product having instructions, wherein execution of the program by a processor causes the processor to carry out one or more elements of the method 200, 300, or 400. In the context of method 200, 300, or 400, the processor may be a processor of a UE (such as a processor(s) 604 of a wireless device 602 that is a UE, as described herein), and the instructions may be, for example, located in the processor and/or on a memory of the UE (such as a memory 606 of a wireless device 602 that is a UE, as described herein). In the context of method 200, 300, or 400, the processor may be a processor of a network device (such as a processor(s) 622 of a network device 620, as described herein), and the instructions may be, for example, located in the processor and/or on a memory of the network device (such as a memory 624 of a network device 620, as described herein).

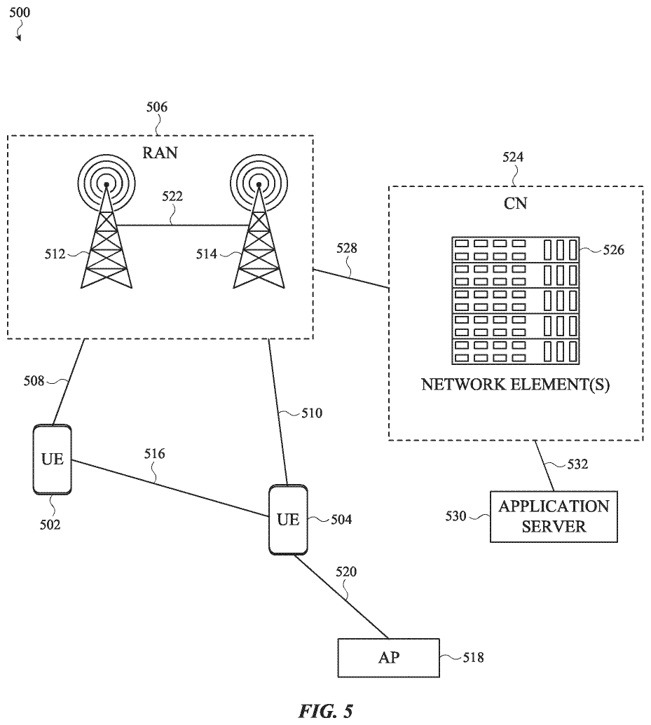

FIG. 5 illustrates an example architecture of a wireless communication system 500, according to embodiments disclosed herein. The following description is provided for an example wireless communication system 500 that operates in conjunction with the LTE system standards and/or 5G or NR system standards as provided by 3GPP technical specifications.

As shown by FIG. 5, the wireless communication system 500 includes UE 502 and UE 504 (although any number of UEs may be used). In this example, the UE 502 and the UE 504 are illustrated as smartphones (e.g., handheld touchscreen mobile computing devices connectable to one or more cellular networks), but may also comprise any mobile or non-mobile computing device configured for wireless communication.

The UE 502 and UE 504 may be configured to communicatively couple with a RAN 506. In embodiments, the RAN 506 may be NG-RAN, E-UTRAN, etc. The UE 502 and UE 504 utilize connections (or channels) (shown as connection 508 and connection 510, respectively) with the RAN 506, each of which comprises a physical communications interface. The RAN 506 can include one or more base stations, such as base station 512 and base station 514, that enable the connection 508 and connection 510.

In this example, the connection 508 and connection 510 are air interfaces to enable such communicative coupling, and may be consistent with RAT(s) used by the RAN 506, such as, for example, an LTE and/or NR.

In some embodiments, the UE 502 and UE 504 may also directly exchange communication data via a sidelink interface 516. The UE 504 is shown to be configured to access an access point (shown as AP 518) via connection 520. By way of example, the connection 520 can comprise a local wireless connection, such as a connection consistent with any IEEE 802.11 protocol, wherein the AP 518 may comprise a Wi-Fi® router. In this example, the AP 518 may be connected to another network (for example, the Internet) without going through a CN 524.

In embodiments, the UE 502 and UE 504 can be configured to communicate using orthogonal frequency division multiplexing (OFDM) communication signals with each other or with the base station 512 and/or the base station 514 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 512 or base station 514 may be implemented as one or more software entities running on server computers as part of a virtual network. In addition, or in other embodiments, the base station 512 or base station 514 may be configured to communicate with one another via interface 522. In embodiments where the wireless communication system 500 is an LTE system (e.g., when the CN 524 is an EPC), the interface 522 may be an X2 interface. The X2 interface may be defined between two or more base stations (e.g., two or more eNBs and the like) that connect to an EPC, and/or between two eNBs connecting to the EPC. In embodiments where the wireless communication system 500 is an NR system (e.g., when CN 524 is a 5GC), the interface 522 may be an Xn interface. The Xn interface is defined between two or more base stations (e.g., two or more gNBs and the like) that connect to 5GC, between a base station 512 (e.g., a gNB) connecting to 5GC and an eNB, and/or between two eNBs connecting to 5GC (e.g., CN 524).

The RAN 506 is shown to be communicatively coupled to the CN 524. The CN 524 may comprise one or more network elements 526, which are configured to offer various data and telecommunications services to customers/subscribers (e.g., users of UE 502 and UE 504) who are connected to the CN 524 via the RAN 506. The components of the CN 524 may be implemented in one physical device or separate physical devices including components to read and execute instructions from a machine-readable or computer-readable medium (e.g., a non-transitory machine-readable storage medium).

In embodiments, the CN 524 may be an EPC, and the RAN 506 may be connected with the CN 524 via an S1 interface 528. In embodiments, the S1 interface 528 may be split into two parts, an S1 user plane (S1-U) interface, which carries traffic data between the base station 512 or base station 514 and a serving gateway (S-GW), and the S1-MME interface, which is a signaling interface between the base station 512 or base station 514 and mobility management entities (MMEs).

In embodiments, the CN 524 may be a 5GC, and the RAN 506 may be connected with the CN 524 via an NG interface 528. In embodiments, the NG interface 528 may be split into two parts, an NG user plane (NG-U) interface, which carries traffic data between the base station 512 or base station 514 and a user plane function (UPF), and the S1 control plane (NG-C) interface, which is a signaling interface between the base station 512 or base station 514 and access and mobility management functions (AMFs).

Generally, an application server 530 may be an element offering applications that use internet protocol (IP) bearer resources with the CN 524 (e.g., packet switched data services). The application server 530 can also be configured to support one or more communication services (e.g., VoIP sessions, group communication sessions, etc.) for the UE 502 and UE 504 via the CN 524. The application server 530 may communicate with the CN 524 through an IP communications interface 532.

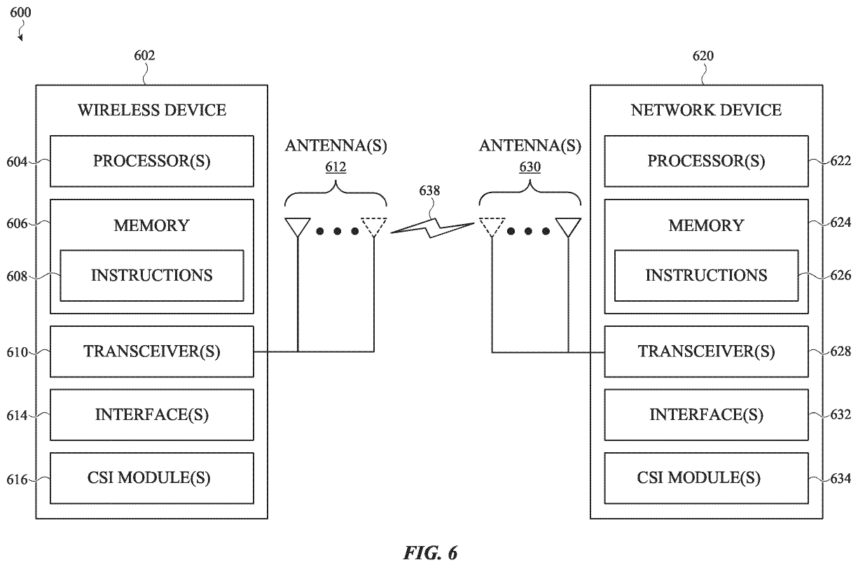

FIG. 6 illustrates a system 600 for performing signaling 640 between a wireless device 602 and a network device 620, according to embodiments disclosed herein. The system 600 may be a portion of a wireless communication system as herein described. The wireless device 602 may be, for example, a UE of a wireless communication system. The network device 620 may be, for example, a base station (e.g., an eNB or a gNB) of a wireless communication system.

The wireless device 602 may include one or more processor(s) 604. The processor(s) 604 may execute instructions such that various operations of the wireless device 602 are performed, as described herein. The processor(s) 604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 602 may include a memory 606. The memory 606 may be a non-transitory computer-readable storage medium that stores instructions 608 (which may include, for example, the instructions being executed by the processor(s) 604). The instructions 608 may also be referred to as program code or a computer program. The memory 606 may also store data used by, and results computed by, the processor(s) 604.

The wireless device 602 may include one or more transceiver(s) 610 that may include radio frequency (RF) transmitter and/or receiver circuitry that use the antenna(s) 612 of the wireless device 602 to facilitate signaling (e.g., the signaling 640) to and/or from the wireless device 602 with other devices (e.g., the network device 620) according to corresponding RATs.

The wireless device 602 may include one or more antenna(s) 612 (e.g., one, two, four, or more). For embodiments with multiple antenna(s) 612, the wireless device 602 may leverage the spatial diversity of such multiple antenna(s) 612 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 602 may be accomplished according to precoding (or digital beamforming) that is applied at the wireless device 602 that multiplexes the data streams across the antenna(s) 612 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 602 may implement analog beamforming techniques, whereby phases of the signals sent by the antenna(s) 612 are relatively adjusted such that the (joint) transmission of the antenna(s) 612 can be directed (this is sometimes referred to as beam steering).

The wireless device 602 may include one or more interface(s) 614. The interface(s) 614 may be used to provide input to or output from the wireless device 602. For example, a wireless device 602 that is a UE may include interface(s) 614 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 610/antenna(s) 612 already described) that allow for communication between the UE and other devices and may operate according to known protocols (e.g., Wi-Fi®, Bluetooth®, and the like).

The wireless device 602 may include one or more CSI measurement and reporting module(s) 616. The CSI measurement and reporting module(s) 616 may be implemented via hardware, software, or combinations thereof. For example, the CSI measurement and reporting module(s) 616 may be implemented as a processor, circuit, and/or instructions 608 stored in the memory 606 and executed by the processor(s) 604. In some examples, the CSI measurement and reporting module(s) 616 may be integrated within the processor(s) 604 and/or the transceiver(s) 610. For example, the CSI measurement and reporting module(s) 616 may be implemented by a combination of software components (e.g., executed by a DSP or a general processor) and hardware components (e.g., logic gates and circuitry) within the processor(s) 604 or the transceiver(s) 610.

The CSI measurement and reporting module(s) 616 may be used for various aspects of the present disclosure, for example, aspects of FIGS. 1-4. The CSI measurement and reporting module(s) 616 may be configured to, for example, configure CSI measurement and reporting and transmit one or more CSI reports to another device (e.g., to the network device 620).

The network device 620 may include one or more processor(s) 622. The processor(s) 622 may execute instructions such that various operations of the network device 620 are performed, as described herein. The processor(s) 604 may include one or more baseband processors implemented using, for example, a CPU, a DSP, an ASIC, a controller, an FPGA device, another hardware device, a firmware device, or any combination thereof configured to perform the operations described herein.

The network device 620 may include a memory 624. The memory 624 may be a non-transitory computer-readable storage medium that stores instructions 626 (which may include, for example, the instructions being executed by the processor(s) 622). The instructions 626 may also be referred to as program code or a computer program. The memory 624 may also store data used by, and results computed by, the processor(s) 622.

The network device 620 may include one or more transceiver(s) 628 that may include RF transmitter and/or receiver circuitry that use the antenna(s) 630 of the network device 620 to facilitate signaling (e.g., the signaling 640) to and/or from the network device 620 with other devices (e.g., the wireless device 602) according to corresponding RATs.

The network device 620 may include one or more antenna(s) 630 (e.g., one, two, four, or more). In embodiments having multiple antenna(s) 630, the network device 620 may perform MIMO, digital beamforming, analog beamforming, beam steering, etc., as has been described.

The network device 620 may include one or more interface(s) 832. The interface(s) 832 may be used to provide input to or output from the network device 620. For example, a network device 620 that is a base station may include interface(s) 832 made up of transmitters, receivers, and other circuitry (e.g., other than the transceiver(s) 628/antenna(s) 630 already described) that enables the base station to communicate with other equipment in a core network, and/or that enables the base station to communicate with external networks, computers, databases, and the like for purposes of operations, administration, and maintenance of the base station or other equipment operably connected thereto.

The network device 620 may include one or more CSI report configuration module(s) 634. The CSI report configuration module(s) 634 may be implemented via hardware, software, or combinations thereof. For example, the CSI report configuration module(s) 634 may be implemented as a processor, circuit, and/or instructions 626 stored in the memory 624 and executed by the processor(s) 622. In some examples, the CSI report configuration module(s) 634 may be integrated within the processor(s) 622 and/or the transceiver(s) 628. For example, the CSI report configuration module(s) 634 may be implemented by a combination of software components (e.g., executed by a DSP or a general processor) and hardware components (e.g., logic gates and circuitry) within the processor(s) 622 or the transceiver(s) 628.

The CSI report configuration module(s) 634 may be used for various aspects of the present disclosure, for example, aspects of FIGS. 1-4. The CSI report configuration module(s) 634 may configure CSI reports that are to be transmitted by another device (e.g., the wireless device 602).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a transceiver; and
a processor configured to:
transmit, via the transceiver to a network, UE capability information that corresponds with performance monitoring for artificial intelligence (AI) model-based channel state information (CSI) compression at the UE;
in accordance with the UE capability information, receive, via the transceiver and from the network:
configuration and activation instructions for performing the AI model-based CSI compression; and
a network configuration on assisted information for the performance monitoring;
in accordance with the received network configuration on assisted information for the performance monitoring, monitor performance of the AI model-based CSI compression; and
based on the monitored performance of the AI model-based CSI compression, transmit, via the transceiver to the network, a preference of the UE for the AI model-based CSI compression.

2. The UE of claim 1, wherein:
the UE capability information that corresponds with the performance monitoring for the artificial intelligence (AI) model-based CSI compression comprises at least one of:
a capability of the UE to download a decoder model; or
a capability of the UE to perform inferencing of the decoder model.

3. The UE of claim 2, wherein:
in accordance with the UE capability information including the capability to perform inferencing of the decoder model, the network configuration on assisted information for the performance monitoring for the artificial intelligence (AI) model-based CSI compression comprises:
an intermediate metric threshold of a metric, the metric including one of: a generalized cosine similarity metric, a squared generalized cosine similarity, or a normalized mean square error (MSE) metric; and
in accordance with the UE capability information not including the capability to perform inferencing of the decoder model or to download the decoder model from the network, use a decoder trained at the UE to calculate a reconstructed precoder matrix index (PMI) for the performance monitoring.

4. The UE of claim 3, wherein:
the processor is configured to:
perform the inferencing of the decoder model;
generate an intermediate threshold of an eigen-vector;
compare the generated intermediate threshold of the eigen-vector with the intermediate metric threshold for the performance monitoring; and
based on the comparison, determine whether AI model-based CSI feedback meets requirements.

5. The UE of claim 4, wherein:
the intermediate threshold of the eigen-vector is generated by averaging measurements over a particular time window, the particular time window is configured at the UE using the network configuration on assisted information for the performance monitoring.

6. The UE of claim 2, wherein:
in accordance with the UE capability information including no capability to perform the inferencing of the decoder model, the network configuration on assisted information for the performance monitoring for the artificial intelligence (AI) model-based CSI compression comprises:
a block error rate (BLER) threshold of a physical downlink shared channel (PDSCH).

7. The UE of claim 6, wherein:
the processor is configured to:
calculate a channel quality indicator (CQI) value based on an eigen-vector and the BLER threshold of the PDSCH;
compare the calculated PDSCH BLER with the BLER threshold of the PDSCH in the UAI configuration; and
based on the comparison, determine whether the AI model-based CSI compression meets requirements.

8. The UE of claim 7, wherein:
the PDSCH BLER based on the CQI value associated with the eigen-vector is calculated by averaging measurements over a particular time window, the particular time window is configured at the UE using the network configuration on assisted information for the performance monitoring.

9. The UE of claim 2, wherein:
in accordance with the UE capability information including no capability to perform the inferencing of the decoder model, the network configuration on assisted information for performance monitoring at the UE comprises:
an intermediate metric including one of: a generalized cosine similarity metric, a squared generalized cosine similarity, or a normalized mean square error (MSE) metric.

10. The UE of claim 9, wherein:
the processor is configured to:
receive, via the transceiver from the network, precoder-matrix indicator (PMI) or a decoder output;
calculate an eigen-vector of the intermediate metric of channel state information reference signal (CSI-RS) measurements;
compare the calculated eigen-vector to the received PMI or decoder output; and
based on the comparison, generate a CSI report to transmit to the network.

11. The UE of claim 10, wherein:
the PMI or the decoder output is periodically received by the UE as a PDSCH transmission.

12. The UE of claim 10, wherein:
a CSI-RS used for the performance monitoring for the artificial intelligence (AI) model-based CSI compression is indicated in a CSI-RS configuration to the UE.

13. The UE of claim 1, wherein the configuration for performing the AI-based CSI compression comprises an identification (ID) of an AI model.

14. The UE of claim 1, wherein the preference of the UE for the AI model-based CSI compression comprises one of:
deactivation of the AI model-based CSI compression; or
switching to another AI model-based CSI compression.

15. The UE of claim 14, wherein the preference is indicated to the network using a UAI message or an uplink MAC control element (UL MAC CE).

16. The UE of claim 14: wherein:
the processor is configured to:
receive, via the transceiver from the network, using one of radio resource control (RRC) signaling, a MAC CE, or downlink control information (DCI), configuration and instructions for deactivating the AI model-based CSI compression, or switching to the other AI model-based CSI compression.

17. A network device, comprising:
a transceiver; and
a processor configured to:
transmit, via the transceiver to a user equipment (UE), instructions for performance monitoring for artificial intelligence (AI) model-based CSI compression, an AI model identified using an AI model identification (ID); and
a configuration for a UE report for a network-side performance monitoring, the UE report for the network-side performance monitoring comprises an eigen-vector or a measured CSI reference signal (CSI-RS);
receive, via the transceiver from the UE,
a CSI report based on CSI compression performed using the AI model; and
the UE report for the network-side performance monitoring;?? evaluate the CSI report and the UE report received from the UE; and in accordance with the evaluation, transmit, to the UE, instructions to:
deactivate the CSI compression using the AI model;
switch to non-AI model-based CSI compression; or
switch to another AI model-based CSI compression.

18. The network device of claim 17, wherein:
the configuration for the UE report for the network-side performance monitoring is received via radio resource control (RRC) signaling, a downlink MAC control element (DL MAC CE), or a downlink control information (DCI);
the UE report for the network-side performance monitoring comprises one or more of:
an eigen-vector;
a measured CSI reference signal (CSI-RS);
an AI model-based CSI feedback; or
non-AI model-based CSI feedback.

19. A method, comprising:
transmitting, for a user equipment (UE) to a network, UE capability information that corresponds with performance monitoring for artificial intelligence (AI) model-based channel state information (CSI) compression at the UE;
receiving, from the network, configuration and activation instructions for performing the AI model-based CSI compression;
receiving, from the network, a network configuration on assisted information for the performance monitoring at the UE;
in accordance with the received network configuration on assisted information for the performance monitoring, monitoring the performance of the AI-based CSI compression; and
based on the monitored performance of the AI model-based CSI compression, transmitting, to the network, a preference of the UE for the AI model-based CSI compression.

20. The method of claim 19, wherein:
the preference of the UE for the AI model-based CSI compression comprises one of:
deactivation of the AI model-based CSI compression; or
switching to another AI model-based CSI compression; and
the preference is indicated to the network using a UAI message or an uplink MAC control element (UL MAC CE).
